(19) United States
(12) Patent Application Publication
(10) Pub. No.: US 2020/0170084 A1
(43) Pub. Date: May 28, 2020

(54) Solid-State Cooking Apparatus

(71) Applicant: Ampleon Netherlands B.V., Nijmegen (NL)

(72) Inventor: Yevhen Tymofieiev, Nijmegen (NL)

(21) Appl. No.: 16/685,064

(22) Filed: Nov. 15, 2019

(30) Foreign Application Priority Data
Nov. 23, 2018 (NL) 2022064

(51) Int. Cl. H05B 6/68; H05B 6/72; H05B 6/64; H05B 6/70

(52) U.S. Cl. CPC H05B 6/686; H05B 6/72; H05B 6/6402; H05B 2206/044; H05B 6/701; H05B 6/707; H05B 6/687

(57) ABSTRACT

The present invention relates to a solid-state cooking apparatus. The present invention further relates to a field applicator for applying an electromagnetic wave, preferably to a cooking cavity of a solid-state cooking apparatus. The field applicator comprises a quadrature coupler for splitting a radiofrequency signal over a pair of antenna elements. The isolated port of the quadrature coupler is connected to a predefined load. The solid-state cooking apparatus is operable in at least one of a first mode and second mode, wherein, in the first mode, the predefined load equals an RF short or an RF open, and, in the second mode, the predefined load equals a dummy load configured to dissipate the signal received at the isolated port of the quadrature coupler.

### CROSS REFERENCE TO RELATED APPLICATIONS

The present application claims priority to Netherlands Patent Application NL2022064, which was filed in the Netherlands Patent Office on Nov. 23, 2018, and which is hereby incorporated in its entirety herein by reference.

### FIELD OF INVENTION

The present invention relates to a solid-state cooking apparatus. The present invention further relates to a field applicator for applying an electromagnetic wave, preferably to a cooking cavity of a solid-state cooking apparatus.

### BACKGROUND

Conventional cooking apparatuses based on magnetrons, the so-called microwave ovens, are more and more replaced by solid-state cooking (SSC) apparatuses. In these devices, the power generating element is not formed by a magnetron but by a semiconductor-based radiofrequency (RF) power amplifier (PA) system. These PA systems comprise power amplifiers. Examples of such amplifiers are Silicon-based laterally diffused metal-oxide semiconductor (LDMOS) amplifiers or Gallium Nitride field-effect transistors (FETs).

In solid-state cooking systems, the input return losses of the cooking cavity can be poor due to the unpredictable loading. Different types and amounts of food need to be cooked in domestic applications. In addition, the RF properties of the food are constantly changing during the cooking process, for example due to changing water content. Furthermore, the cooking cavity can be loaded with highly reflective materials such as metal pans, pots, possibly by accident.

The RF performance of the PA depends on the output load that is presented at the output of the amplifier. Usually, a PA is tuned to deliver the best performance with a frequency-independent load, most often 50 Ohm. However, in practice, during cooking, the effective load seen by the PA will deviate strongly from this nominal impedance. This mismatch results in degraded efficiency and output power, and may even result in damage to the PA or other components used in the amplifying path.

To prevent damage to the PA during use, the known SSC systems are equipped with ferrite circulators or isolators. These elements redirect power reflected from the cooking cavity into a load where it can be dissipated. The main drawbacks of the circulator are additional losses, increased costs, and a low reliability at high power levels.

EP 2 182 774 A1 discloses a solid-state cooking apparatus according to the preamble of claim 1. A further solid-state cooking apparatus is known from EP 3 136 001 A1.

### SUMMARY

An object of the present invention is to provide a solid-state cooking apparatus in which at least some of the problems mentioned above are at least partially alleviated.

This object is achieved with the solid-state cooking apparatus as defined in claim 1, which comprises a cooking cavity, a power amplifier system for generating a radiofrequency ‘RF’ signal, and a field applicator configured to provide an electromagnetic wave into the cooking cavity based on the generated RF signal.

The field applicator comprises a splitting element for splitting the generated radiofrequency signal into a first signal and a second signal, a first antenna element for emitting a first wave based on the first signal into the cooking cavity, and a second antenna element for emitting a second wave based on the second signal into the cooking cavity.

The first and second waves are preferably each linearly polarized electromagnetic waves. The first and second linearly polarized electromagnetic waves preferably form, together and in the cooking cavity, a circularly or elliptically polarized electromagnetic wave. A circularly polarized wave is preferably formed but small to larger deviations in amplitude or phase relationship between the first and second signals may result in elliptically polarized electromagnetic waves.

The splitting element comprises a quadrature coupler having an input port connected to the power amplifier system, an isolated port connected to a predefined load, a first output port connected to the first antenna element, and a second output port connected to the second antenna element. Furthermore, the solid-state cooking apparatus is operable in at least one of a first mode and second mode, wherein, in the first mode, the predefined load equals an RF short or an RF open, and, in the second mode, the predefined load equals a dummy load configured to dissipate the signal received at the isolated port of the quadrature coupler.

The quadrature coupler is configured so that a signal input to one port among the input port and the isolated port is split into two signals emerging at the first and second output ports and which are 90 degrees apart in phase. Similarly, a signal input to one port among the first output port and the second output port is split into two signals emerging at the input and isolated ports and which are 90 degrees apart in phase. A particular example of a quadrature coupler is a 3 dB hybrid coupler in which the signal is equally split. Further or other types of quadrature couplers include branch-line couplers, Lange couplers, waveguide couplers, substrate integrated waveguide (SIW) couplers, and overlay couplers.

Typically, the quadrature coupler is designed using transmission lines having a particular characteristic impedance. The predefined load, when intended to dissipate the power emerging at the isolated port, may have an impedance that is equal to this characteristic impedance. On the other hand, when the predefined load is intended to reflect the power emerging from the isolated port back into the quadrature coupler, the load may be an RF short or an RF open. Here, it is noted that in practical situations a true short or open does not exist at RF frequencies. Rather, the RF open should be considered as being a large, mostly capacitive, impedance that causes a large reflection at the isolated port—predefined load interface. Similarly, the RF short should be considered as being a small, mostly inductive, impedance that causes a large reflection at the isolated port—predefined load interface.

The apparatus may further comprise a switching unit that connects one of the RF short, the RF open, or the dummy load to the isolated port of the quadrature coupler. The apparatus may additionally comprise a controller for controlling the switching unit in dependence of a desired operating mode of the solid-state cooking apparatus. The controller can be configured to control the switching unit based on one or more parameters that have been determined using measurements. For example, the switching unit can be controlled based on a measured voltage, current, power, and/or impedance.

The solid-state cooking apparatus may be equipped with a power estimating system that comprises one or more power estimating units that estimate an amount of power. This amount of power may be related to the power that is reflected back from the cooking cavity and that is received at the first and/or second output port. Alternatively, the power estimating unit(s) is/are configured to determine the power that is dissipated in or reflected by the predefined load, or the power that is outputted by the power amplifier system. Based on the estimated power(s) the controller may control the switching unit.

The controller may be configured to switch the operating mode from the first mode to the second mode when at least one of the estimated power(s) exceeds a first threshold. Additionally or alternatively, the controller may be configured to switch the operating mode from the second mode to the first mode when at least one of the estimated power(s) is below a second threshold. The second threshold may be set lower than the first threshold to prevent excessive switching.

For example, the controller may be configured to switch the operating mode from the first mode to the second mode when the power reflected back from the cooking cavity and received at the first and/or second output ports and/or the power reflected by or dissipated in the predefined load exceeds a first threshold. The different determined power levels may each be compared to a respective threshold. Alternatively, the different determined power levels are combined into a single value which is then compared to a first threshold.

Alternatively, the controller may be configured to switch the operating mode from the second mode to the first mode when the power reflected back from the cooking cavity and received at the first and/or second output ports and/or the power reflected by or dissipated in the predefined load is below a second threshold.

The first threshold may be set in such a manner that when the reflected power becomes too high, possibly causing dangerous conditions for the power amplifier system, the switch to the second mode is made to allow the reflected power to be dissipated. On the other hand, the second threshold may be set in such a manner that when the reflected power is low, the switch to the first mode is made. In this mode, the reflected power is re-inserted into the cavity, thereby improving cooking and/or system efficiency.

To perform the power measurement function, the power estimating units may each comprise a directional coupler, preferably a bi-directional coupler. Additionally or alternatively, the power dissipated in the dummy load may be determined using a voltage or current meter attached to the dummy load. In another example, the power outputted by the power amplifier system is determined based on the DC power dissipated in the power amplifier system, or power amplifier in that power amplifier system, and the temperature of the system or amplifier. For example, the outputted RF power can be computed by subtracting the dissipated power from the inputted DC power, wherein the dissipated power is calculated based on the measured temperature.

Each of the power estimating units may be arranged a) between the first output port and the first antenna element, or b) between the second output port and the second antenna element, or c) between the isolated port and the predefined load.

At least one power estimating unit may be configured to determine a power dissipated in the dummy load, wherein the at least one power estimating unit comprises a current or voltage meter coupled to the dummy load.

At least one of the switching unit, the controller, and the power estimating units can be comprised in the field applicator.

The solid-state cooking apparatus may include a double input circular polarization antenna, in which the first and second antenna elements are comprised. Alternatively, the first and second antenna elements may be mutually orthogonal arranged antennas such as dipole antennas, folded dipole antennas, bowtie dipole antennas, loop antennas, slot antennas, patch arrays, waveguides with orthogonal probes, and spiral antennas.

The first and second antenna elements and the splitter can be realized using substrate integrated waveguide technology. For example, the field applicator may comprise a dielectric substrate that is covered on opposite sides, e.g. a top and bottom side, with a conductive layer, such as a metal layer. Here, the metal layer on the top side is usually patterned to define electrical tracks. The metal layer on the bottom side typically forms a ground layer. The substrate can be in the form of a printed-circuit board or laminated structure that may comprise one or more dielectric layers. In case the substrate comprises a plurality of dielectric layers, conductive layers may be arranged in between the dielectric layers.

A plurality of vias may be provided that extend through the substrate and that electrically connect the conductive layers on the opposite sides. The plurality of vias and the conductive layers define the splitting element and the first and second antenna element. More in particular, the plurality of vias, and the conductive layers on the opposite sides may form a dielectric filled waveguide element. Such element may for example be the splitting element, the first antenna element, or the second antenna element.

The present invention is not limited to substrate integrated waveguide technology. Other technologies for realizing the field applicator, such as a microstrip or strip line may also be used.

The power amplifier system may comprise a RF power amplifier package in which a RF power amplifier is accommodated or a semiconductor die on which a RF power amplifier is realized, wherein the RF power amplifier package or the semiconductor die is arranged on one of the opposite sides of the dielectric substrate.

The power amplifier system or parts thereof may be integrated into and/or arranged on the field applicator. For example, a power amplifier of the power amplifier system may be arranged in the field applicator. Furthermore, the field applicator may at least partially extend in the cooking cavity.

The solid-state cooking apparatus may additionally comprise a further power amplifier system for generating a further radiofrequency ‘RF’ signal, and a further field applicator configured to provide a further electromagnetic wave into the cooking cavity based on the generated further RF signal. In this case, the further power amplifier system and the further field applicator are configured to provide a further circularly or elliptically polarized electromagnetic wave into the cooking cavity that has a polarity that is opposite to the polarity of said circularly or elliptically polarized electromagnetic wave. Due to the opposite polarities, a wave generated by one field applicator and picked up by the other field applicator will in first instance not reach the power amplifier connected to the quadrature coupler of that field applicator. Rather, when the other field applicator is connected to a dummy load, the picked up wave will be dissipated. Accordingly, isolation between adjacent field applicators, or the power amplifiers connected to those field applicators can be improved.

The further field applicator may comprise a further splitting element for splitting the generated further radiofrequency signal into a third signal and a fourth signal, a third antenna element for emitting a third wave based on the third signal into the cooking cavity, and a fourth antenna element for emitting a fourth wave based on the fourth signal into the cooking cavity.

The further splitting element may comprise a further quadrature coupler having an input port connected to the further power amplifier system, an isolated port connected to a further predefined load, a first output port connected to the third antenna element, and a second output port connected to the fourth antenna element. In the first mode, the predefined load equals an RF short or an RF open, and, in the second mode, the predefined load equals a dummy load configured to dissipate the signal received at the isolated port of the further quadrature coupler. The third and fourth waves are each linearly polarized electromagnetic waves, said third and fourth linearly polarized electromagnetic waves together forming, in the cooking cavity, said further circularly or elliptically polarized electromagnetic wave.

The solid-state cooking apparatus may further comprise a further switching unit that connects one of the RF short, the RF open, or the dummy load to the isolated port of the further quadrature coupler, wherein the further switching unit is controlled by the controller. The RF open, RF short, or dummy load are preferable the same as their counterparts for the earlier mentioned field applicator.

More in particular, at least one of the further field applicator and the further power amplifier system is identical to said field applicator and said power amplifier system, respectively. Among adjacently arranged field applicators and further applicators everything can be identical apart from which port of the quadrature coupler the (further) power amplifier system and predefined load are connected to.

The present invention is not limited to two field applicators. Any number of field applicators could be arranged provided that adjacently arranged field applicators are configured to introduce electromagnetic waves into the cooking cavity with opposite polarities.

According to a further aspect, the present invention provides a field applicator that comprises the field applicator as defined above.

### BRIEF DESCRIPTION OF THE DRAWINGS

Next, the present invention will be described in more detail referring to the appended drawings, wherein:

FIG. 1 illustrates a known solid-state cooking apparatus;

FIG. 2 schematically illustrates an embodiment of a field applicator in accordance with the present invention;

FIG. 3 illustrates a microstrip implementation of (part of) the field applicator of FIG. 2;

FIG. 4 illustrates a substrate integrated waveguide implementation of (part of) the field applicator of FIG. 2; and

FIG. 5 illustrates a solid-state cooking apparatus in which two field applicators are arranged in the cooking cavity.

### DETAILED DESCRIPTION

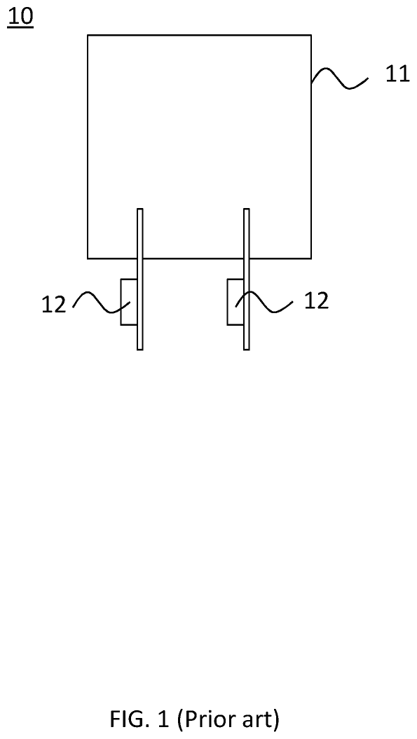

FIG. 1 illustrates a known solid-state cooking apparatus 10. It comprises a cooking cavity 11, and one or more field applicators 12. Field applicators 12 comprise amplifying elements, or are connected to amplifying elements, such as RF amplifiers or RF amplifier systems. The signals amplified by these amplifiers are inserted by the field applicators into cooking cavity 11. To that end, field applicators 12 are equipped with one or more antennas.

It is a known problem that waves emitted by a field applicator 12 could be reflected off the metal walls of cooking cavity 11 and could be picked up by the antennas of field applicator 12. Another known problem is that not all of the available power is emitted into cooking cavity 11. Some of the power delivered to the antennas is reflected at the antenna back into the field applicator. A further problem exists in that a wave emitted by a first field applicator can be picked up by an adjacently arranged second field applicator.

Within the context of the present invention, the signals that are inserted back into the field applicator, whether it relates to signals reflected at the antenna, signals received from adjacent field applicators, or signals received as a consequence of reflection by the cooking cavity walls, will jointly be referred to as signals or waves received from the cooking cavity. The present invention particularly relates to signals received from the cooking cavity that are the consequence of reflection by the cooking cavity walls.

In short, the present invention proposes an approach by which the deteriorating effects of received signals or waves can be mitigated.

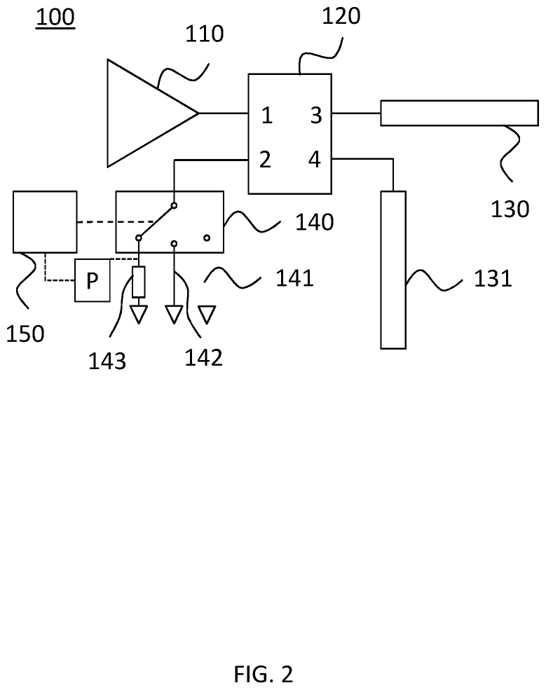

FIG. 2 schematically illustrates an embodiment of a field applicator 100 in accordance with the present invention. This field applicator may for example be used in a solid-state cooking apparatus 10 shown in FIG. 1.

Field applicator 100 comprises an RF power amplifier system 110, which may be a balanced, or single-ended amplifier system, optionally based on a Doherty, push-pull or other type of amplifier. The output of amplifier system 110 is fed to an input port 1 of quadrature coupler 120. Isolated port 2 of coupler 120 is connected to a switching unit 140 which is able to connect isolated port 2 either to an RF open 141, an RF short 142, or a dummy load 143, such as 50 Ohm.

A first output port 3 of coupler 120 is coupled to a first antenna element 130, and a second output port 4 of coupler 120 to a second antenna element 130. The signals fed to first and second antenna elements 130, 131 differ in phase, for example by 90 degrees. Each of antenna elements 130, 131 emits a linearly polarized wave into cooking cavity 11. However, the phase difference between the signals provided to antenna elements 130, 131, optionally together with the orientation and/or positioning of the antenna elements 130, 131 results in the generation of a circularly, or at least substantially circularly, polarized wave being emitted in cavity 11. It should be noted that in FIG. 2, the phase difference between the signals inputted into the antenna elements 130, 131 is generated by coupler 120. More in a particular, the signal emerging at second output port 4 in response to a signal inputted at port 1 lags by 90 degrees relative to the signal emerging at first output port 3.

RF power amplifier system 110 may also be arranged outside of field applicator 100. In such case, field applicator 100 comprises a suitable connector for allowing the RF signal generated by RF power amplifier system 110 to be inputted into field applicator 100. Similarly, switching unit 140, controller 150, dummy load 143, RF open 141, RF short 142 may all or partially arranged outside field applicator 100.

Switching unit 140 is controlled by controller 150. In FIG. 2, a power estimating unit P is indicated that measures the power dissipated in dummy load 143. When dummy load 143 is purely resistive, power estimating unit P can embodied as a current or voltage meter. Controller 150 uses the estimated power to control switching unit 140 as will be described later.

It should be noted that power estimating unit P may be arranged at other positions even outside field applicator 100. For example, a power estimating unit may be arranged in between coupler 120 and one or more of the antenna elements 130, 131, in between isolated port 2 and switching unit 140, in between switching unit 140 and RF open 141, RF short 142, or predefined load 143, or in between power amplifier system 110 and input port 1. Consequently, power estimating unit P may be configured to determine the power that is reflected back from the cooking cavity and received at the first and/or second output port, and/or the power that is dissipated in or reflected by predefined load, and/or the power that is outputted by the power amplifier system. Controller 150 is configured to control switching unit 140 based on one or more of the estimated powers.

Next, the working principles of field applicator 100 will be explained in detail.

An RF signal generated by RF power amplifier system 110 is fed to input port 1 of coupler 120. This signal will at least substantially equally be split over first and second output ports 3, 4. Although the amplitudes of these signals are at least substantially equal, they differ in phase. More in particular, the signal outputted at port 4 lags by 90 degrees relative to the signal outputted at port 3. Next, these signals are fed to respective antenna elements 130, 131, which each will generate a linearly polarized electromagnetic wave. Due to the 90 degrees phase difference, these waves will combine into a circularly polarized wave. More in particular, antenna element 130 is configured to output a wave that is polarized in a first direction, and antenna element 131 will output a wave that is polarized in a second direction perpendicular to the first direction. Without loss of generality, it will be assumed that the circularly polarized wave corresponds to a right-hand circularly polarized wave.

Next, the situation will be described in which the circularly polarized wave is reflected by the cavity walls and is picked up by antenna elements 130, 131. Here, the signal picked up by antenna element 130 will be referred to as Vi_1 and the signal picked up by antenna element 131 as V2_i. As signals Vi_1 and Vi_2 correspond to the two linearly polarized components of the circularly polarized wave they have a 90 degrees phase difference. Due to the reflection, the orientation of the wave will have shifted from a right-hand to a left-hand orientation and the propagation direction will have been inverted. As a result, Vi_2 lags by 90 degrees relative to Vi_1.

Coupler 120 is symmetric in the sense that a signal inputted at port 3 will emerge at port 1 and at port 2, at least substantially equally split, wherein the signal at port 2 lags by 90 degrees relative to the signal at port 1. Similarly, a signal inputted at port 4 will emerge at port 1 and at port 2, at least substantially equally split, wherein the signal at port 1 lags by 90 degrees relative to the signal at port 2.

A signal Vi_1 at port 3 will result in a 3 dB attenuated signal at port 1 and a 3 dB attenuated signal at port 2 that lags the corresponding signal at port 1 by 90 degrees. Similarly, a signal Vi_2 at port 4 will result in a 3 dB attenuated signal at port 2 and a 3 dB attenuated signal at port 1 that lags the corresponding signal at port 2 by 90 degrees. As Vi_2 already lags 90 degrees with respect to Vi_1, the signals at port 1, i.e. the signals related to Vi_1 and Vi_2, will cancel each other whereas the signals at port 2 add in phase.

Depending on the load connected to isolated port 2 by switching unit 140, the signal at port 2 will either be reflected back into coupler 120, where it will result in a left-hand circularly polarized wave being emitted into cavity 11, or it will be absorbed in the load. The formed case occurs when the predefined load equals the RF short 142 or the RF open 141. The latter case occurs when the predefined load is a resistive dummy load 143. By controlling switching unit 140 using controller 150, it becomes possible to either achieve improved stability and ruggedness, e.g. by allowing the signal to be dissipated in dummy load 143, or to improve overall efficiency of the system by allowing the signal, which would otherwise be lost, to be reflected, by RF open 141 or RF short 142, through coupler 120 back into cavity 11.

To control the switching process, controller 150 relies on power measurements or other measurements that are indicative of the power received from cavity 11 obtained from one or more power estimating units P as described above. The estimations and/or measurements are compared jointly or individually to one or more thresholds. Based on this or these comparison(s), controller 150 may decide to control switching unit 140 to switch between a first mode, in which RF open 141 or RF short 142 is connected to isolated port 2, and a second mode, in which dummy load 142 is connected to isolated port 2.

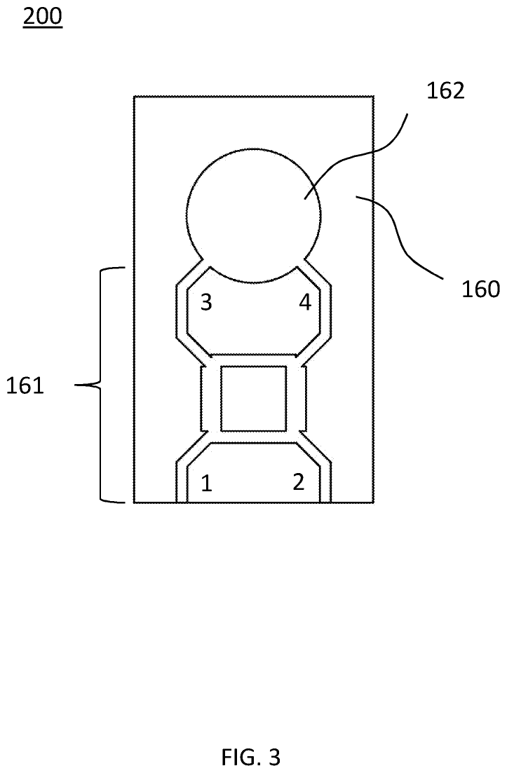

FIG. 3 illustrates an example of a field applicator 200 in accordance with the present invention. This figure illustrates a microstrip implementation on a single or multiple layer printed-circuit board 160 or other substrate. It comprises a branch-line coupler 161 and a circular patch antenna 162 in which the first and second antenna elements are integrated.

In FIG. 3, the RF power amplifier system, controller, switching unit, and the various loads for connecting to isolated port 2 are not included in field applicator 200. In other embodiments, printed-circuit board 160 is larger and may also accommodate some or all of these components.

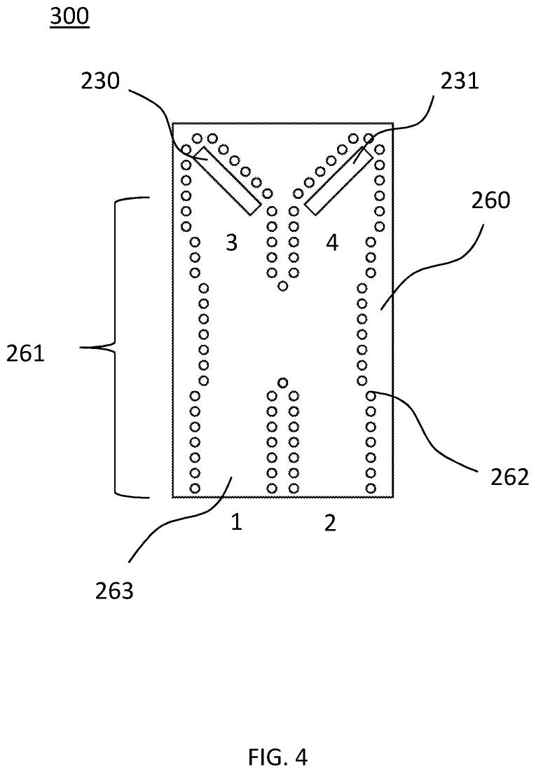

FIG. 4 illustrates a substrate-integrated waveguide (SIW) implementation of a field applicator 300 that corresponds in terms of functionality to the embodiment in FIG. 3. Again, a single or multiple layer printed-circuit board 260 or other substrate is used. However, in this case, the top and bottom surfaces of printed-circuit board 260 are almost completely covered by a metal layer 263. In addition, two slots 230, 231 are arranged in metal layer 263. These slots optionally extend inside and/or through printed-circuit board 260 and/or the metal layer on the backside. Each slot 230, 231 forms a respective slot antenna.

A plurality of vias 262 connect the metal layers on both sides of printed-circuit board 260, thereby forming substrate integrated waveguide structures. For example, a dielectric filled waveguide component is formed in the shape of a 3 dB hybrid coupler 261.

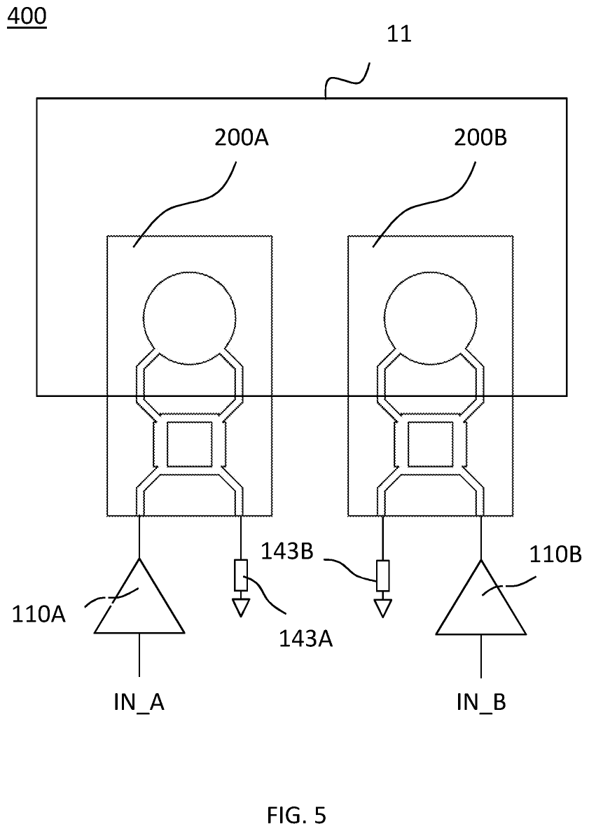

FIG. 5 illustrates a solid-state cooking apparatus in which at least two field applicators 200A, 200B are arranged, preferably adjacently. In this embodiment, the field applicators apply electromagnetic waves into cavity 11 that have opposite polarity. In FIG. 5 this is achieved by having RF power amplifier 110A and dummy load 143A connected to different ports of the hybrid coupler of field applicator 200A when compared to RF power amplifier 110B and dummy load 143B. This will result in the polarity of the electromagnetic wave emitted by field applicator 110A being one of a right-hand polarization and a left-hand polarization, and the polarity of the electromagnetic wave emitted by field applicator 110B being the other of a right-hand polarization and a left-hand polarization. Consequently, when the wave generated by field applicator 200A is picked up by field applicator 200B, it will be dissipated in load 143B connected to field applicator 200B, and vice versa. Accordingly, by arranging field applicators in this manner, the isolation between adjacent field applicators can be improved.

The embodiment in FIG. 5 is not limited to using dummy loads as predefined loads. More in particular, the field applicators of FIGS. 3 and 4 can equally be used. In addition, the concept of FIG. 2 can be applied for each field applicator separately. However, it is preferred if each field applicator is connected to one and the same of an RF open, RF short, and dummy load. It should be noted that the exact components values, e.g. resistance, inductance, or capacitance, for similar components for different field applicators may be different.

Further to the above, the signal provided to the inputs IN_A and IN_B of the different power amplifiers 110A, 110B may be the same signal or a separate signal.

In the above, the invention has been described using detailed embodiments thereof. The skilled person will however understand that the present invention is not limited to these embodiments. Instead, several modifications are possible without deviating from the scope of the invention which is defined in the appended claims.

### LIST OF REFERENCE NUMBERS

P power estimating unit
1 input port
2 isolated port
3 first output port
4 second output port
10 solid-state cooking apparatus
11 cooking cavity
12 field applicator
100 field applicator
110, 110A, 110B RF amplifier
120 quadrature coupler
130 first antenna element
131 second antenna element
140 switching unit
141 RF open
142 RF short
143, 143A, 143B dummy load
150 controller
160 printed-circuit board
161 branch-line coupler
162 circular patch antenna
200, 200A, 200B field applicator
230 slot for first slot antenna
231 slot for second slot antenna
260 printed-circuit board
261 substrate-integrated waveguide 3 dB hybrid coupler
262 via
263 metal layer
300 field applicator

1. A solid-state cooking apparatus comprising:
a cooking cavity;
a power amplifier system for generating a radiofrequency (RF) signal; and
a field applicator configured to provide an electromagnetic wave into the cooking cavity based on the generated RF signal, wherein the field applicator comprises:
a splitting element for splitting the generated RF signal into a first signal and a second signal;
a first antenna element for emitting a first wave based on the first signal into the cooking cavity; and
a second antenna element for emitting a second wave based on the second signal into the cooking cavity;
wherein the splitting element comprises a quadrature coupler having an input port connected to the power amplifier system, an isolated port connected to a predefined load, a first output port connected to the first antenna element, and a second output port connected to the second antenna element;
and wherein the solid-state cooking apparatus is operable in at least one of a first mode and second mode, wherein, in the first mode, the predefined load equals an RF short or an RF open, and, in the second mode, the predefined load equals a dummy load configured to dissipate a signal received at the isolated port of the quadrature coupler.

2. The solid-state cooking apparatus according to claim 1, wherein the first and second waves are each linearly polarized electromagnetic waves, the first and second linearly polarized electromagnetic waves together forming, in the cooking cavity, a circularly or elliptically polarized electromagnetic wave.

3. The solid-state cooking apparatus according to claim 1, wherein the quadrature coupler comprises a 3 dB hybrid coupler.

4. The solid-state cooking apparatus according to claim 1, wherein the RF short or RF open is configured to reflect the signal received from the isolated port of the quadrature coupler back into the quadrature coupler via the isolated port.

5. The solid-state cooking apparatus according to claim 1, further comprising a switching unit that connects one of the RF short, the RF open, or the dummy load to the isolated port of the quadrature coupler.

6. The solid-state cooking apparatus according to claim 5, further comprising a controller for controlling the switching unit in dependence of a desired operating mode of the solid-state cooking apparatus.

7. The solid-state cooking apparatus according to claim 5, further comprising a power estimating system comprising one or more power estimating units for estimating an amount of power,
wherein the controller is configured to control the switching unit based on the estimated amount of power,
and wherein the amount of power is at least one of:
reflected back from the cooking cavity and received at at least one of the first output port or the second output port,
dissipated in or reflected by the predefined load, or
outputted by the power amplifier system.

8. The solid-state cooking apparatus according to claim 7,
wherein the desired operating mode is one of the first mode or the second mode,
and wherein the controller is configured to switch between the first and second modes by at least one of:
switching the desired operating mode from the first mode to the second mode when at least one of: (i) power reflected back from the cooking cavity and received at at least one of the first output port or the second output port, or (ii) power reflected by the predefined load, exceeds a first threshold; or
switching the desired operating mode from the second mode to the first mode when at least one of: (i) power reflected back from the cooking cavity and received at at least one of the first output port or second output port, or (ii) power reflected by the predefined load, is below a second threshold.

9. The solid-state cooking apparatus according to claim 7,
wherein the one or more power estimating units each comprise a directional coupler,
wherein each of the one or more power estimating units is arranged between the first output port and the first antenna element, or between the second output port and the second antenna element, or between the isolated port and the predefined load,
and wherein at least one of the one or more power estimating units is configured to determine a power dissipated in the dummy load, the at least one of the one or more power estimating units comprising a current or voltage meter coupled to the dummy load.

10. The solid-state cooking apparatus according to claim 7, wherein at least one of the switching unit, the controller, and the power estimating units are comprised in the field applicator.

11. The solid-state cooking apparatus according to claim 1, wherein the first and second antenna elements are one of: elements of a double input circular antenna, or elements of a mutually orthogonal antenna arrangement,
wherein the mutually orthogonal antenna arrangement is one of dipole antennas, folded dipole antennas, bowtie dipole antennas, loop antennas, slot antennas, patch arrays, waveguides with orthogonal probes, or spiral antennas.

12. The solid-state cooking apparatus according to claim 1, wherein the first and second antenna elements and the splitting element are realized using substrate integrated waveguide technology.

13. The solid-state cooking apparatus according to claim 9, wherein the field applicator comprises:
a dielectric substrate covered on opposite sides with a conductive layer;
a plurality of vias extending through the dielectric substrate and electrically connecting the conductive layers on the opposite sides;
wherein the plurality of vias and the conductive layers define the splitting element and the first and second antenna element;
wherein the power amplifier system comprises a RF component, wherein the RF component is one of a RF power amplifier package in which a RF power amplifier is accommodated, or a semiconductor die on which a RF power amplifier is realized,
and wherein the RF component is arranged on one of the opposite sides of the dielectric substrate.

14. The solid-state cooking apparatus according claim 1, wherein the power amplifier system is at least one of integrated into, or arranged on the field applicator.

15. The solid-state cooking apparatus according claim 1, wherein the field applicator at least partially extends in the cooking cavity.

16. The solid-state cooking apparatus according to claim 2, further comprising:
a further power amplifier system for generating a further RF signal;
a further field applicator configured to provide a further electromagnetic wave into the cooking cavity based on the generated further RF signal;
wherein the further power amplifier system and further field applicator are configured to provide a further circularly or elliptically polarized electromagnetic wave into the cooking cavity that has a polarity that is opposite to the polarity of the circularly or elliptically polarized electromagnetic wave.

17. The solid-state cooking apparatus according to claim 16, wherein the further field applicator comprises:
a further splitting element for splitting the generated further RF signal into a third signal and a fourth signal;
a third antenna element for emitting a third wave based on the third signal into the cooking cavity;
a fourth antenna element for emitting a fourth wave based on the fourth signal into the cooking cavity;
wherein the further splitting element comprises a further quadrature coupler having an input port connected to the further power amplifier system, an isolated port connected to a further predefined load, a first output port connected to the third antenna element, and a second output port connected to the fourth antenna element;
wherein, in the first mode, the predefined load equals an RF short or an RF open, and, in the second mode, the predefined load equals a dummy load configured to dissipate the signal received at the isolated port of the further quadrature coupler;
and wherein the third and fourth waves are each linearly polarized electromagnetic waves, the third and fourth linearly polarized electromagnetic waves together forming, in the cooking cavity, the further circularly or elliptically polarized electromagnetic wave.

18. The solid-state cooking apparatus according to claim 16, further comprising:
a switching unit that connects one of the RF short, the RF open, or the dummy load to the isolated port of the quadrature coupler,
a controller for controlling the switching unit in dependence of a desired operating mode of the solid-state cooking apparatus,
and a further switching unit that connects one of the RF short, the RF open, or the dummy load to the isolated port of the further quadrature coupler, the further switching unit being controlled by the controller.

19. The solid-state cooking apparatus according to claim 16, wherein at least one of the further field applicator and the further power amplifier system is identical to the field applicator and the power amplifier system, respectively.

20. The solid-state cooking apparatus according to claim 16, wherein the field applicator and further field applicator are adjacently arranged.

21. A field applicator comprising:
a splitting element for splitting a radiofrequency (RF) signal into a first signal and a second signal;
a first antenna element for emitting a first wave based on the first signal into a cooking cavity; and
a second antenna element for emitting a second wave based on the second signal into the cooking cavity;
wherein the splitting element comprises a quadrature coupler having an input port connected to a power amplifier system, an isolated port connected to a predefined load, a first output port connected to the first antenna element, and a second output port connected to the second antenna element;
and wherein the field applicator is configured for operation in a solid-state cooking apparatus that is operable in at least one of a first mode and second mode, wherein, in the first mode, the predefined load equals an RF short or an RF open, and, in the second mode, the predefined load equals a dummy load configured to dissipate a signal received at the isolated port of the quadrature coupler.

22. The solid-state cooking apparatus according claim 1, wherein the power amplifier system is at least one of integrated into, or arranged on the field applicator,
and wherein the field applicator at least partially extends in the cooking cavity.
